(19) United States
(12) Patent Application Publication
(10) Pub. No.: US 2012/0160751 A1
(43) Pub. Date: Jun. 28, 2012

(54) OXIDATION POND INCLUDING NEUTRALIZING AGENT FOR TREATING ACID MINE DRAINAGE

(75) Inventors: Dong-Kil LEE, Daejeon (KR); Gil-Jae YIM, Daejeon (KR); Young-Wook CHEONG, Daejeon (KR); Sang-Woo JI, Daejeon (KR)

(73) Assignee: KOREA INSTITUTE OF GEOSCIENCE AND MINERAL RESOURCES(KIGAM), Daejeon (KR)

(21) Appl. No.: 13/020,958

(22) Filed: Feb. 4, 2011

(30) Foreign Application Priority Data
Dec. 24, 2010 (KR) 10-2010-0134455

(51) Int. Cl. C02F 1/52; C02F 1/66

(52) U.S. Cl. 210/170.09

(57) ABSTRACT

Provided is an oxidation pond for treating acid mine drainage discharged from an abandoned mine. The oxidation pond comprises: an inlet into which mine drainage is introduced; a retention pond in which the mine drainage introduced into the inlet resides; and an outlet through which the mine drainage is discharged from the retention pond, so that iron in the mine drainage is oxidized and precipitated during residence of the mine drainage in the retention pond, wherein a neutralizing agent that increases the pH of the mine drainage to accelerate the iron precipitation reaction is placed in the retention pond.

### CROSS-REFERENCE TO RELATED APPLICATION

This application claims priority to and the benefit of Korean Patent Application No 10-2010-0134455 filed on 24 Dec. 2010, the disclosure of which is incorporated herein by reference in its entirety.

### BACKGROUND OF THE INVENTION

1. Field of the Invention

The present invention relates to technology for reducing environmental pollution, and more particularly, to an oxidation zone which is used in a passive treatment method for acid mine drainage discharged from abandoned mines or the like.

2. Description of Related Art

An oxidation pond is used in a passive treatment method for treating acid mine drainage (AMD). In the oxidation pond, mine drainage resides for a given time during which ferrous iron contained in the mine drainage precipitates as iron oxide by an oxidation reaction with oxygen.

The most important factor in designing the oxidation pond is the retention time of mine drainage which should generally be at least 48 hours. In design conditions of the oxidation pond, the inflow conditions of mine drainage are determined based on the area that comes in contact with oxygen. Namely, the oxidation pond is designed based on the nominal retention time obtained by dividing the total volume of the oxidation pond by the inflow rate of mine drainage, assuming that the flow rate of the mine drainage is 1 L/sec per 100 m² of the contact area.

The size and shape of most oxidation ponds vary depending on their locations and land costs, but it is general that the internal structure of the oxidation pond is completely filled with mine drainage without any structure. This appearance of the oxidation pound is the same worldwide.

The flow pattern of mine drainage that flows into the oxidation pond varies depending on the inlet and outlet sizes and shapes of the oxidation pond, the flow rate of mine drainage, etc. In order to visually understand this flow pattern, it is useful to use a method of analyzing the flow pattern on the basis of the flow paths and characteristics included in mine drainage that flows into the inlet.

The present inventors evaluated a conventional oxidation pond. Specifically, the flow pattern of the conventional oxidation pond was examined using edible dye Blue No. 2 harmless to the human body, brine was used to calculate the retention time of mine drainage, and a CTD-Diver was used to measure electrical conductivity. In the measurement method, a tracer (brine) was introduced into an inlet for mine drainage in order to measure retention time that is the time taken for mine drainage to reach the outlet, and the range of diffusion of the dye during the time.

The oxidation pond used in the experiment was a Sukbong oxidation pond located at Mungyeong-shi, Gyeongsangbuk-do, Korea, which had an octagonal shape, a size of 14 m (width)×6 m (length), and a total depth of 1.5 m. Considering that the thickness of the precipitate at the bottom of the oxidation pond is 0.35 m at present and that the height from the top of the oxidation pond to the surface of the water is 0.4 m at present, the average depth of the oxidation pond at the time of the measurement is about 0.75 m. The inlet into which mine drainage flows is composed of a pipe having an inner diameter of 40 cm, and the level of water in the pipe is about 0.15 m away from the bottom of the pipe. The outlet is composed of a rectangular concrete conduit having a width of 0.4 m and a height of 0.5 m. The flow rate of mine drainage which flows into the oxidation pond is 86.4 m³/hr.

Edible dye Blue No. 2 was injected into the inlet of the Sukbong oxidation pond at a given concentration, and the diffusion path of the dye with time was examined. After the injection, the dye showed a straight flow pattern connecting the inlet with the outlet, and little or no portion of the dye flowed to the surrounding area. A portion of the dye showed a tendency to flow to the surrounding area, but this movement is regarded as diffusion caused by the difference in concentration. The time taken for the dye to reach the outlet after injection was measured to be 95 seconds.

Also, the time taken for brine introduced into the inlet of the oxidation pond to reach the outlet to show the change in electrical conductivity was measured to be 261 seconds after the introduction of brine into the inlet, and the time taken for electrical conductivity in the outlet to become constant was measured to be 295 seconds after the introduction of brine. Accordingly, the time taken for brine to be sensed at the outlet was 4.35 minutes after the introduction of brine.

Meanwhile, computational flow analysis was performed in order to understand the flow characteristics of mine drainage that flows into the Sukbong oxidation pond. As a result, in the plane of the Sukbong oxidation pond, a line connecting the inlet to the outlet showed the highest flow rate, and in the longitudinal section of the Sukbong oxidation pond, the flow rate gradually increased toward the outlet. However, it was shown that portions having a high flow rate were located mainly at the surface of the water.

Also, when examining the flow pattern of mine drainage in the Sukbong oxidation pond, the mine drainage flowed along a straight line, connecting the inlet to the outlet, at a high rate, and was discharged to the outlet, but a vortex flow was formed at both sides of the straight line, indicating that there was a region in which the mine drainage was only circulated between the inlet and the outlet without being discharged.

Moreover, the retention time of mine drainage in the Sukbong oxidation pond was measured. As a result, mine drainage flowing along the straight line connecting the inlet to the outlet showed a very short retention time, whereas mine drainage placed surrounding the straight line showed a long retention time. Namely, it is concluded that regions other than the above straight line region are not regions through which mine drainage flows, but regions in which mine drainage stagnates.

When examining the retention time distribution in the longitudinal section of the Sukbong oxidation pond, it was shown that the retention time was significantly longer in the lower portion than the upper portion.

In summary, it can be seen that the main flow region in the oxidation pond is the straight line region connecting the inlet to the outlet and also that, in the process in which mine drainage flows in and out of the oxidation pond, there is little or no flow in the deep portion of the oxidation pond, and mine drainage mostly flows along the water surface.

As a result, it can be seen that the oxidation pond is divided into a main flow region, which connects the inlet to the outlet, and a stagnation region, and that mine drainage introduced into the oxidation pond flows along the main flow region, and the remaining region is a stagnation region which does not participate in the flow of the mine drainage.

Namely, the introduced mine drainage flows along a specific flow region without flowing throughout the oxidation pond. Thus, mine drainage that is flows from the inlet directly to the outlet through the main flow region of the oxidation pond has a very short retention time in the oxidation pond. Also, the space of the oxidation pond is not efficiently used due to the stagnation region of the oxidation pond, and thus the function of the oxidation pond cannot be sufficiently performed.

Particularly, if the retention time of mine drainage in the oxidation pond is short as described above, there is a problem in that the precipitation of ferrous irons by sufficient contact with oxygen is reduced, thus making the subsequent treatment of the mine drainage difficult.

Meanwhile, the rate of a reaction in which iron ions in mine drainage are oxidized by oxygen to precipitate as hydroxides has a deep relationship with the pH of the mine drainage. FIG. 1 is a graphic diagram showing the change in the rate of an iron precipitation reaction according to the change in pH. As can be seen from the graph of FIG. 1, the reaction rate rapidly increases as the pH rises from about 3 toward a neutral pH.

Accordingly, there is a need to develop a specific technology that can increase the retention time of mine drainage in an oxidation pond at, at the same time, accelerate the precipitation of iron in mine drainage using the change in pH.

### SUMMARY OF THE INVENTION

The present invention has been made in order to solve the above-described problems occurring in the prior art, and it is an object of the present invention to provide an oxidation pond which has an improved structure such that the pH of mine drainage can rise to increase the efficiency of precipitation of iron and such that mine drainage can be widely diffused over the entire region of the oxidation pond to increase the retention time of the mine drainage, thus increasing the efficiency of precipitation and removal of iron in the mine drainage.

According to one aspect of the present invention, there is provided an oxidation pond for treating mine drainage, comprising: an inlet into which mine drainage is introduced; a retention pond in which the mine drainage introduced into the inlet resides; and an outlet through which the mine drainage is discharged from the retention pond, so that iron in the mine drainage is oxidized and precipitated during retention of the mine drainage in the retention pond, wherein a neutralizing agent that increases the pH of the mine drainage to accelerate the precipitation reaction of iron is placed in the retention pond.

The neutralizing agent is preferably suspended in water of the retention pond so that it is prevented from being coated with iron hydroxide.

Also, the neutralizing agent may be made of a natural limestone mass.

The neutralizing agent preferably comprises limestone fine powders and a binder forming the limestone fine powders into one mass, wherein the binder is dissolved in the mine drainage while the limestone fine powders come in contact with the mine drainage.

Also, the neutralizing agent may be made of a limestone mass having a number of cracks formed by pressing.

Also, the neutralizing agent is preferably disposed closer to the inlet than the outlet.

Also, the wall surface of the retention pond may be made of limestone.

In one embodiment of the present invention, the oxidation pond may further comprise a dispersion guide member which is placed in the front of the inlet such that the mine drainage introduced into the retention pond through the inlet

In one embodiment of the present invention, the oxidation pond may further comprise a dispersion guide member which is placed in the front of the inlet so that mine drainage introduced through the inlet forms a dispersed flow in the retention pond.

The dispersion guide member allows mine drainage to be introduced in an indirect direction, crossing a direct direction connecting the inlet to the outlet, in an amount larger than in the direct direction, allows mine drainage to be introduced in the indirect direction, forming a large angle with the direct direction, in an amount than in the direct direction, and allows mine drainage to be introduced into the lower portion of the retention pond in an amount larger than the upper portion.

More specifically, the dispersion guide member has a bent plate shape and is placed in the retention pond while surrounding the inlet, whereby it blocks the of mine drainage, wherein the length of the lower portion of the guide member, which blocks mine drainage that is discharged along the indirect direction formed at a relatively large angle with the direct direction connecting the inlet to the outlet, is relatively short.

Also, another type of dispersion guide member has a bent plate shape and is placed in the retention pond while surrounding the inlet, whereby it blocks the flow of the mine drainage, wherein a number of discharge holes are formed in the dispersion guide member, in which the sum of the areas of the discharge holes formed at the lower portion of the dispersion guide member is larger than the sum of the areas of the discharge holes formed at the upper portion, and the sum of the areas of the discharge holes formed along the indirect direction forming a relatively large angle with the direct direction connecting the inlet to the outlet is larger than the sum of the areas of the discharge holes formed along the indirect direction forming a relatively small angle with the direct direction.

A discharge pipe that guides mine drainage may be coupled to each discharge hole along the discharge hole.

Also, the length of the discharge pipe disposed at the lower portion of the dispersion guide member is longer than that of the discharge pipe disposed at the upper portion, and the length of the discharge pipe formed along the indirect direction forming a relatively large angle with the direct direction is longer than that of the discharge pipe formed along the indirect direction forming a relatively small angle with the direct direction.

Meanwhile, another type of dispersion guide member is formed in a plate shape along the indirect direction crossing the direct direction connecting the inlet to the outlet and serves to guide the flow of the mine drainage introduced into the inlet.

The dispersion guide member comprises a first wing surface having a curved shape, and a second wing surface which is coupled with the first wing surface and is formed symmetrically with the first wing surface, so that the mine drainage can be dispersed along the first wing surface and the second wing surface in opposite directions.

Also, the upper portion of the dispersion guide member is more protruded toward the inlet than the lower portion so that the mine drainage is guided toward the lower portion of the retention pond.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 is a graphic diagram showing the change in the rate of an iron precipitation reaction according to the change in pH;

FIG. 2 is a schematic plan view of an oxidation pond for treating mine drainage according to a first embodiment of the present invention;

FIG. 3 is a schematic cross-sectional view taken along line TIT-TIT of FIG. 2;

FIG. 4 is a schematic view illustrating a second embodiment of the present invention;

FIG. 5 is a schematic view illustrating a third embodiment of the present invention;

FIG. 6 is a schematic perspective view of the dispersion guide member shown in FIG. 2;

FIGS. 7 to 9 are schematic perspective views of other types of dispersion guide members; and

FIG. 10 is a schematic perspective view of another type of a dispersion guide member.

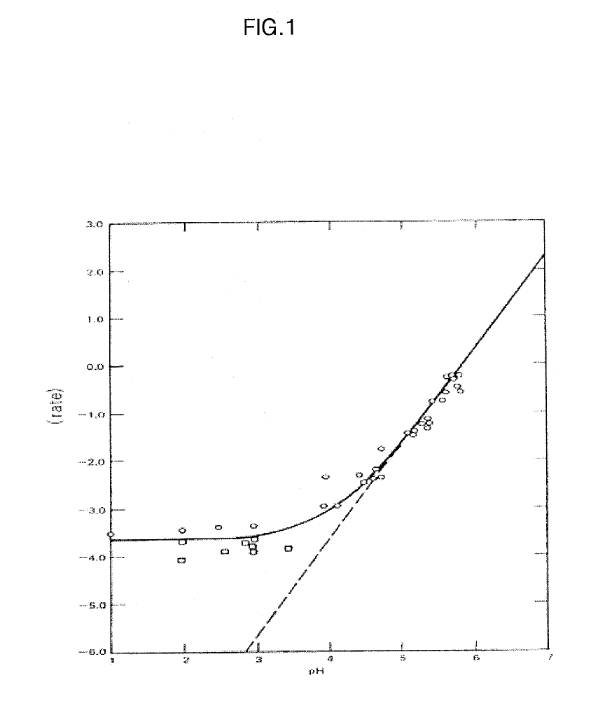

### DETAILED DESCRIPTION OF THE INVENTION

First, acid mine drainage (AMD) to be treated using an oxidation pond according to the present invention will be briefly described. Acid mine drainage is formed when sulfide minerals, including pyrite (FeS₂) and marcasite (FeS), exposed to the atmosphere, are oxidized by a reaction with oxygen and water. It is characterized in that it has an acidic pH and high contents of sulfates and metals, including iron, aluminum and manganese.

The oxidation reaction of pyrite is expressed by the following equations:

FeS₂+7/2O₂+H₂O→Fe²⁺+2SO4²⁻+2H⁺

Fe²⁺+1/4O₂+H⁺→Fe³⁺+1/2H₂O

Fe³⁺+3H₂O→Fe(OH)₃(s)+3H⁺

FeS₂+Fe³⁺+8H₂O→15Fe²⁺+2SO4²⁻+16H⁺

As shown in the above equations, pyrite is oxidized to generate iron ions and sulfate ions and becomes acidic due to hydrogen ions. Such acid mine drainage is formed at a low pH so that heavy metals are easily dissolved in the acid mine drainage and move together with the acid mine drainage. The heavy metals that moved together with the acid mine drainage contaminate the surrounding surface water and underground water to destroy the aquatic ecosystem. Also, the metal ions are oxidized and precipitated as metal hydroxides such as Fe(OH)₃, which generate red brown or white precipitates (called “yellow boy”) at the river bottom to injure the appearance.

In a passive treatment method for mine drainage, an oxidation pond is provided at the entrance of an abandoned mine from which acid mine discharge is discharged, so that iron is precipitated from the acid mine drainage.

Ferrous ions are oxidized to precipitate in the form of hydroxides as shown in the following equation:

4Fe²⁺+O₂+4H⁺→4Fe³⁺+2H₂O

Fe³⁺+3H₂O→Fe(OH)₃(s)+3H⁺

As shown in the equation above, in order for iron ions in mine drainage to precipitate as hydroxides, the iron ions must react either with oxygen in the air or with dissolved oxygen in the mine drainage.

However, as described in Background of the Invention above, if the retention time of mine drainage in the oxidation pond is short, a sufficient reaction will not occur so that a large amount of iron ions can be contained in mine drainage that is discharged from the oxidation pond. If the mine drainage is subsequently treated in a state in which iron was not removed therefrom, various problems will arise.

For example, in a successive alkalinity-producing system (SAPS), mine drainage passes through an organic layer and a limestone layer after passing through an oxidation pond, and iron ions which were not precipitated in the oxidation pond are precipitated in the limestone layer, thus causing the problem of reducing the permeability of the limestone layer.

The present invention provides an oxidation pond which can increase the pH of mine drainage and in which mine drainage resides for a sufficient time, such that iron ions in the mine drainage can be effectively precipitated.

Hereinafter, an oxidation pond for treating mine drainage according to an embodiment of the present invention will be described in further detail with reference to the accompanying drawings.

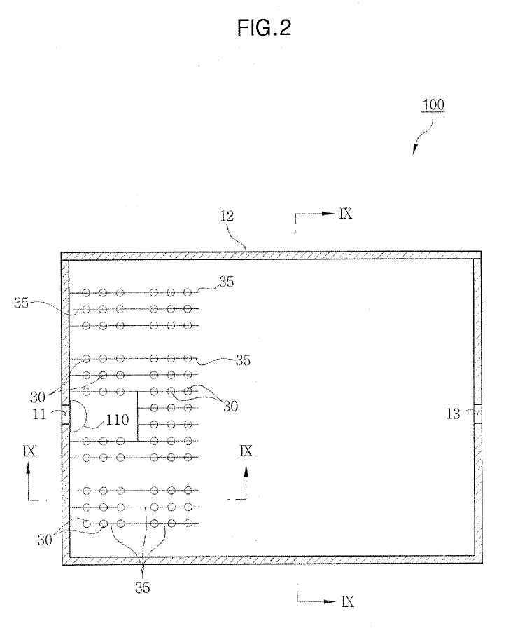

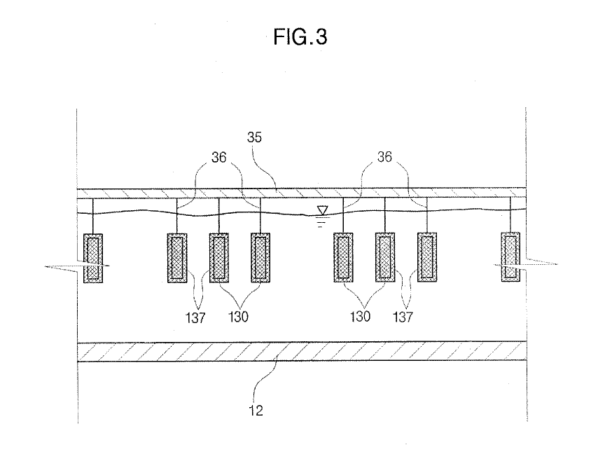

FIG. 2 is a schematic plan view of an oxidation pond for treating mine drainage according to a first embodiment of the present invention; and FIG. 3 is a schematic cross-sectional view taken along line of FIG. 2.

Referring to FIGS. 2 and 3, the oxidation pond for treating mine drainage is a kind of water pond which is disposed adjacent to an abandoned mine or the like to temporarily receive mine drainage from the abandoned mine while precipitating iron from the mine drainage. Accordingly, an oxidation pond 100 according to the present invention comprises: an inlet 11 into which mine drainage flows; a retention pond 12 in which the mine drainage resides; and an outlet 13 through which the mine drainage is discharged.

A naturally formed pond is generally used as the retention pond, but a pond formed by forming outer walls in consideration of geographical conditions may also be used as the retention pond.

In order to increase the pH of the mine drainage introduced through the inlet 11, a neutralizing agent 30 is placed in the retention pond. The neutralizing agent for neutralizing acid mine drainage may be made of various materials, but in this embodiment, limestone is used to increase the pH of mine drainage to at least 3. By introducing limestone into the retention pond 13 to increase the pH of mine drainage, the reaction of precipitation of iron is accelerated.

In conventional treatment systems such as SAPS, a limestone layer was formed at the bottom of the retention pond so that mine drainage passes through the limestone layer downward. However, in the structure of SAPS, iron hydroxide that precipitated from mine drainage is coated on the limestone layer or fills the pores of the limestone, such that mine drainage could not flow through the limestone layer. Particularly, if iron oxide is coated on the surface of limestone, the limestone cannot no longer as a neutralizing agent.

In order to solve this problem, in the present invention, a neutralizing agent 30 is used in such a manner that it is suspended in the water of the retention pond 12. Namely, if the neutralizing agent is suspended in water, the neutralizing agent can be prevented from being coated with iron hydroxide, due to flow rate. The neutralizing agent 30 of limestone can be suspended in water in various manners. In this embodiment, a support 35 is placed on the main baffles 21, and a connection element 36 (e.g., a rope) from which a net bag 37 is hung is suspended on the support 35. Also, the limestone neutralizing agent 30 is placed in the net bag 37, so that mine drainage comes into contact with the limestone neutralizing agent 30 while it flows. Of course, the limestone neutralizing agent may also be connected directly to the connection element without using a structure such as the net bag.

Also, the neutralizing agent 30 may be configured in various forms. In the first embodiment shown in FIG. 3, a natural limestone mass is used.

When selecting the form of the neutralizing agent 30, two considerations should be taken into account: whether coating of the neutralizing agent with iron hydroxide is effectively prevented; and whether neutralization can be smoothly achieved by enlarging the contact area with mine drainage.

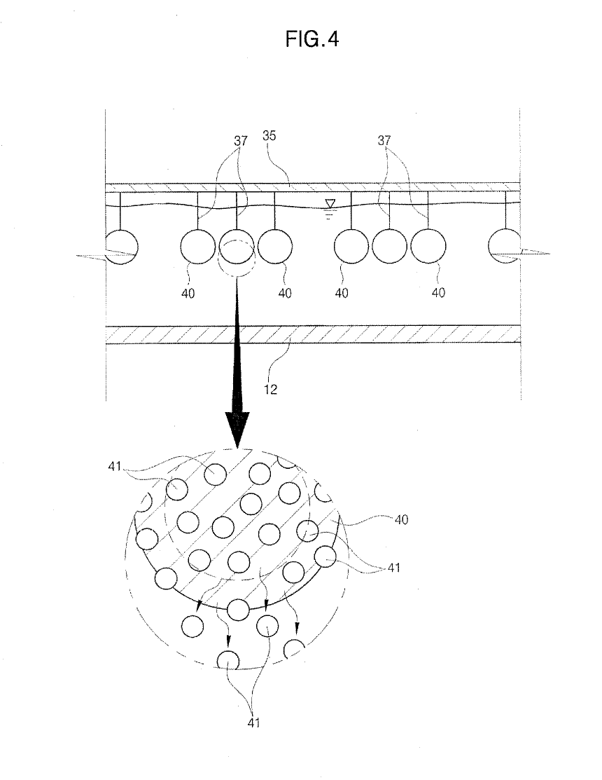

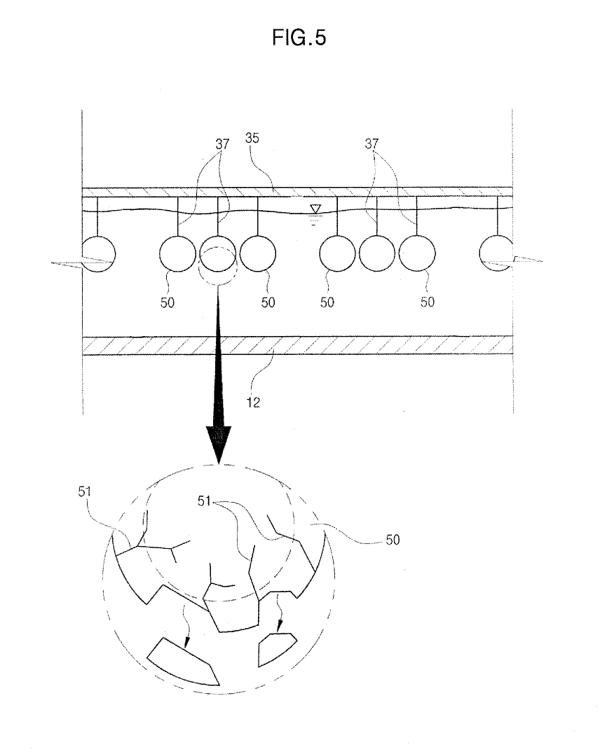

Accordingly, in the neutralizing agents 40 and 50 used in the second embodiment shown in FIG. 4 and the third embodiment shown in FIG. 5, the above two considerations are taken into account.

Specifically, referring to FIG. 4, the neutralizing agent 40 used in the second embodiment is prepared by grinding limestone to form fine powers 41 and forming the fine powders into a mass using a binder 42. As the binder 42, a material that can be dissolved in mine drainage at a constant rate with the passage of time is selected. For example, the material can be polyethylene-vinylacetate (EVA), hydrogel, cellulose acetate silicone rubber, polyurethane and silicone matrix that are also used as a release control agent (RCA) of drug delivery system (DDS). Because the binder 42 is dissolved at a constant rate, the neutralizing agent 40 is not coated with iron hydroxide, and the limestone fine powders 41 are released into mine drainage by the dissolution of the binder 42, wherein the fine powders have a significantly large surface area compared to a limestone mass having the same volume, and thus can rapidly increase the pH of mine drainage.

Namely, as shown by the dotted line in FIG. 5, while the binder 42 is dissolved up to the dotted line, the fine powders 41 that adhered to the dissolved binder are introduced into mine drainage to increase the pH of the mine drainage. The fine powder 41 may be supplied to mine drainage in a given amount with the passage of time until the binder is completely dissolved. Namely, if only the fine powders 41 are placed on the net bag without the binder, the fine powders will be too rapidly introduced into mine drainage, such that they cannot serve to increase the pH of mine drainage for a given period of time.

Also, referring to FIG. 5, the neutralizing agent 50 used in the third embodiment is prepared by pressing a limestone mass to form fine cracks 51. More specifically, the limestone mass is pressed with a three-axial (X-axis, Y-axis and Z-axis) compressor to form cracks. If the limestone having fine cracks 51 is suspended in the retention pond 12, mine drainage will be introduced into the fine cracks 51 so that small limestone pieces will be separated. This can solve the problem in which iron hydroxide is coated on the surface of the limestone, and the fine limestone pieces can be introduced into mine drainage while they can effectively increase the pH of the mine drainage.

Also, the limestone neutralizing agents 30, 40 and 50 used in the first to third embodiments are disposed close to the inlet 11 in the retention pond 12. The portion close to the inlet 11 has a relatively fast flow rate, so that the neutralizing agent is prevented from being coated with iron hydroxide. Moreover, because iron ions have a tendency to precipitate rapidly when they meet iron ions, increasing the pH of mine drainage at the inlet where the mine drainage first comes into contact with oxygen is effective for iron precipitation.

In other embodiments of the present invention, the outer wall of the retention pond 12 may be made of limestone without placing a separate neutralizing agent as described above.

The foregoing description has been made on the structure in which the neutralizing agent 30, 40 or 50 are placed in the retention pond to increase the pH of mine drainage so as to accelerate the reaction of precipitation of iron. The oxidation pond comprises various types of dispersion guide members 110, 120, 130, 140 and 150 such that the pH of mine drainage can be increased and the mine drainage can reside in the retention pond 12 for a sufficient time.

The dispersion guide member is disposed in the inlet 11 so that the mine drainage introduced through the inlet 11 can be dispersed throughout the retention pond 13, whereby the mine drainage can reside in the oxidation pond during a sufficient time.

As described above, in the conventional oxidation pond, mine drainage flows only in a direct direction connecting the inlet to the outlet and does not flow along the left and right sides of the oxidation pond. Also, the mine drainage moves only to the surface of the oxidation pond, and the mine drainage flow is not formed in the deep portion of the oxidation pond.

Accordingly, the dispersion guide member used in the present invention allows the flow of mine drainage to be formed throughout the oxidation pond, unlike the conventional oxidation pond, so that the entire region of the oxidation pond can be used while increasing the retention time of the mine drainage.

Thus, the dispersion guide member have the three fundamental functions: First, the dispersion guide member is disposed at the inlet so that mine drainage introduced into the inlet is introduced into the lower portion of the retention pond in an amount larger than the upper portion. Second, it allows mine drainage to be introduced in an indirect direction crossing a direct direction connecting the inlet to the outlet, in a large amount compared to that in the direct direction. Third, it allows mine drainage to be introduced in an indirect direction forming a large angle with the direct direction, in a large amount compared to that in the direct direction.

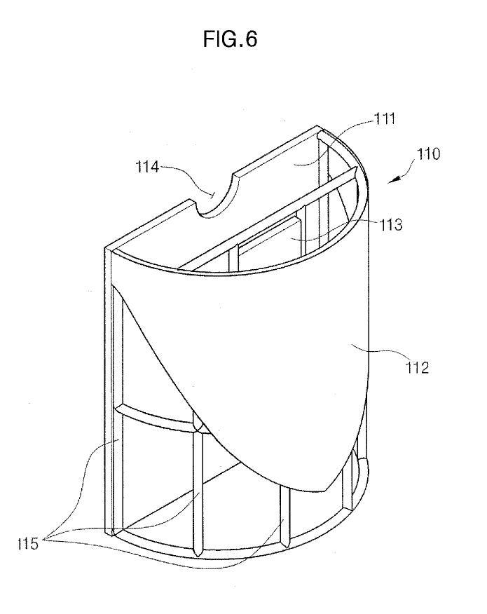

The dispersion guide member for performing the above functions may have various configurations. First, the specific configuration of the dispersion guide member shown in FIG. 6 will now be described.

Referring to FIG. 6, a dispersion guide member 110 comprises an insert plate 110, a semi-circular barrier 112 and a shield plate 113.

The insert plate 111 is a portion that is inserted into the inlet 11 of the oxidation pond. In this embodiment, a circular arc-shaped insertion portion 14 is formed at the upper portion of the insert plate 111 so that it is inserted into the tubular inlet 11.

Also, the semi-circular barrier 112 is disposed around the inlet 11 to serve to block the flow of mine drainage introduced into the inlet. In this embodiment, it has an approximately semi-circular shape, and both ends of the barrier 112 are connected with the both ends of the insert plate 112. Also, the upper end of the semi-circular barrier 112 is approximately equal to the water level of the retention pond or disposed slightly higher than the water level, and the lower end is immersed in the retention pond.

The length of the lower portion of the semi-circular barrier 112 is gradually shorter toward the center portion. Herein, the center portion of the barrier 112 means a portion present on the path along the direct direction connecting the inlet 11 and outlet 12 of the oxidation pond. Alternatively, the center portion may be a portion present on the path along the inflow direction of mine drainage.

In this embodiment, the barrier 112 is semi-circular in shape, and thus the outermost protruded portion in the semi-circular shape is the center part of the barrier, and the portion adjacent to the insert plate 111 is the side of the barrier.

As shown in FIG. 6, the length of the lower portion of the semi-circular barrier 112 is gradually shorter from the center portion toward both sides. Thus, mine drainage introduced through the inlet 11 in an indirect direction in a large amount compared to that in the direct direction. Also, as the length of the lower portion in the direct direction is increased, mine drainage can be introduced more into the lower portion of the retention pond 12 than into the upper portion.

Meanwhile, in this embodiment, the shield plate 113 is disposed between the inlet 11 and the semi-circular barrier 112. When the shield plate is provided, the path of mine drainage introduced from the inlet is blocked before it reaches the barrier 112. The shield plate serves to assist in more efficient dispersion of mine drainage.

Also, in order to place the insert plate 111, the semi-circular barrier 112 and the shield plate 113 in the retention pond 12, a frame 115 is provided. The lower end of the frame 115 is supported at the bottom of the retention pond 12, and the insert plate 111 and the barrier 112 are fixed to the flame 115 by, for example, welding.

The dispersion guide member 110 was placed in the Sukbong oxidation pond, and the dispersing effect thereof was tested.

When the dispersion guide member was not placed, the flow of mine drainage appeared as a straight flow in the direction from the inlet toward the outlet, whereas, after the dispersion guide member 110 has been placed, a specific flow direction did not appear and the mine drainage was dispersed through the oxidation pond.

Also, a vortex flow formed after mine drainage have collided with the dispersion guide member at the inlet of the oxidation pond moved to the lower end of the dispersion guide member, air bubbles were formed in the surrounding area.

This tendency was more clearly shown when a dye was introduced. 2 minutes after introduction of the dye, the dye reached the outlet in the case in which the dispersion guide member was not placed, whereas, after the dispersion guide member has been placed, the dye stayed around the inlet, suggesting that mine drainage was uniformly dispersed throughout the oxidation pond.

Also, in the case in which the dispersion guide member was placed, it could be seen that, 10-20 minutes after introduction of the dye, the dye was dispersed throughout the oxidation pond, and after 20-30 minutes in this state, that is, about 40-50 minutes after introduction of the dye, the dye was uniformly discharged to the outlet.

Meanwhile, in order to accurately obtain the above experimental values, a diver was placed at each of the inlet and outlet of the oxidation pond, and brine was introduced into the inlet to measure the retention time of mine drainage. In the experimental results, the timing at which brine was first introduced into the inlet of the oxidation pond was 886 seconds, and the time taken for brine to reach the outlet was 3,877 seconds, as presumed from the rapid change in electrical conductivity. As a result, it can be seen that the time taken from the inlet to the outlet was a total of 2,991 seconds (49.9 minutes). This retention time is about 11.5 times longer than that in the conventional oxidation pond (4.35 minutes).

Table 1 below shows a comparison of the performance of mine drainage in the oxidation pond between before and after the placement of the dispersion guide member. As can be seen in Table 1, in the case in which the dispersion guide member was not placed, the ratio of measured retention time to nominal retention time was as extremely low as 4.3%, but after the dispersion guide member has been placed, the ratio of measured retention time to nominal retention time was 49.9% corresponding to half the nominal retention time. Also, the retention time was 11.5 times longer than that in the conventional oxidation pond.

TABLE 1

| | No placement of | Placement of | |
|---|---|---|---|
| Physical | dispersion guide | dispersion | Placement/no |
| properties | member | guide member | placement |
| Nominal | 100 | 100 | 1.0 |
| retention time | | | |
| N (min) | | | |
| Measured | 4.35 | 49.9 | 11.5 |
| retention time | | | |
| M (hr) | | | |
| M/N(%) | 4.3 | 49.9 | 11.6 |

As can be seen from the above experimental results, in the case in which the dispersion guide member was placed, mine drainage was uniformly dispersed along the sides and lower portion of the oxidation pond, which were the stagnation regions in the conventional oxidation pond. Thus, the retention time of the mine drainage was increased so that iron in the mine drainage was sufficiently precipitated and removed.

Hereinafter, other types of dispersion guide members will be described with reference to the accompanying drawings.

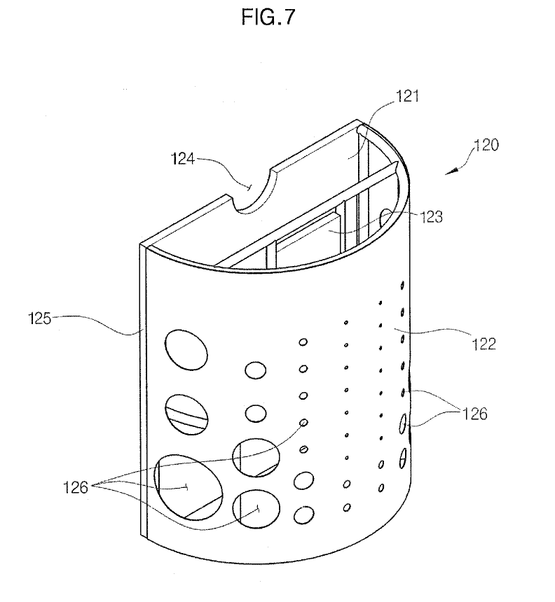

FIGS. 7 to 9 show other types of dispersion guide members.

Referring to FIG. 7, the configuration of the insert plate 121, the shield plate 123 and the frame 125 in the dispersion guide member 120 is the same as the configuration of the dispersion guide member 110 shown in FIG. 7, the lower portion of the semi-circular barrier 122 has a constant length. Although the barrier 122 has a constant length, a plurality of discharge holes 126 are formed in the barrier 122. The discharge holes 126 serve to discharge mine drainage, and the areas of the discharge holes 126 vary depending on the position thereof in the barrier 122.

Namely, the sum of the areas of the discharge holes formed at the upper portion of the barrier 122 is smaller than the sum of the areas of the discharge holes formed at the lower portion formed in the barrier, and the sum of the areas of the discharge holes formed at the sides of the barrier 122 is larger than the sum of the areas of the discharge holes formed at the center portion of the barrier 122. Also, the area of the discharge hole is gradually larger toward the sides of the barrier 122.

As a result, mine drainage is introduced in the direct direction in an amount larger than in the indirect direction, and introduced into the lower portion of the oxidation pond in an amount larger than the lower portion. Thus, mine drainage can be uniformly dispersed throughout the oxidation pond.

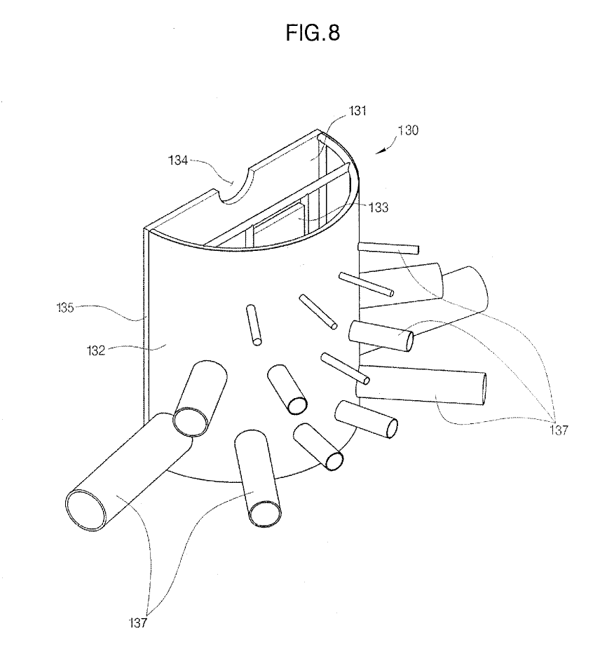

Also, the discharge holes 126 formed at the center portion of the barrier 122 face the direct direction, and the discharge holes formed at the sides face the indirect direction. In order to ensure the directionality of mine drainage that is discharged through each discharge hole, a dispersion guide member 130 as shown in FIG. 8 is used.

Referring to FIG. 8, all the elements of the dispersion guide member 130 are the same as those of the dispersion guide member shown in FIG. 7, except that a discharge pipe 137 is coupled to each discharge hole. Specifically, the discharge pipes 137 are attached along the direction in which the discharge holes 126 are formed, thus improving the directionality of mine drainage that is discharged through the discharge holes. Also, the length of the discharge pipes 137 formed at the lower portion and sides of the barrier 132 is longer than that of the discharge pipes formed at the upper portion and the center portion. Because the diameter of the discharge pipe is the same as the diameter of the discharge hole, the diameters of the discharge pipes at the lower portion and sides of the barrier 132 are larger than those of the discharge pipes formed at the center portion and the upper portion. In FIG. 8, reference numerals 131, 133 and 135 denote an insert plate, a shield plate and a frame, respectively, which have the same configuration and operation as those of the dispersion guide member described with reference to FIG. 6, and thus the description thereof will be omitted.

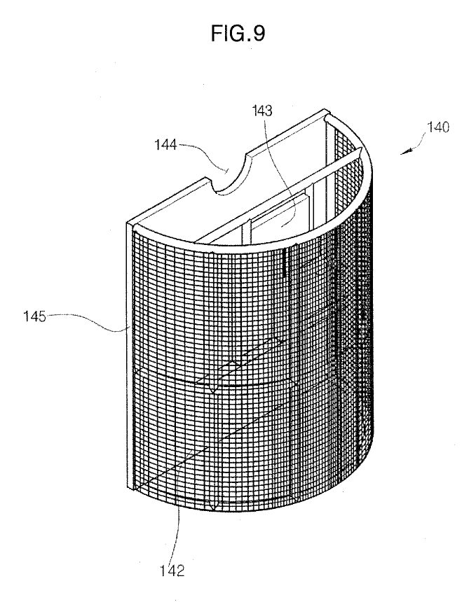

Referring to FIG. 9, the insert plate 141, the shield plate 143 and the frame 145 in the dispersion guide member 140 have the same configuration as that of the above embodiment, except that the semi-circular barrier 142 has a network structure in which a number of through-holes are formed.

Specifically, the semi-circular barrier 142 is woven using horizontal lines and vertical lines into a network structure, and a number of through-holes are formed between the horizontal lines and the vertical lines, through which mine drainage is discharged.

In the barrier 142 of the dispersion guide member 140 shown in FIG. 9, the vertical lines are the horizontal lines are disposed more at the center portion than the sides such that they are closely woven. Also, the upper portion is more closely woven than the lower portion so that the area of the through-holes in the upper portion is smaller. As a result, mine drainage can be introduced into the sides and the lower portion in a larger amount so that it can flow through the oxidation pond.

Although various types of dispersion guide members 110, 120, 130 and 140 have been described for illustrative purposes only, the height of the barrier, the direction and size of the discharge holes, etc., may changed in relation to the type of oxidation pond and the main flow direction of mine drainage in the oxidation pond.

Although the above embodiments all illustrate the formation of the semi-circular barrier, another type of barrier will be described in the following embodiment.

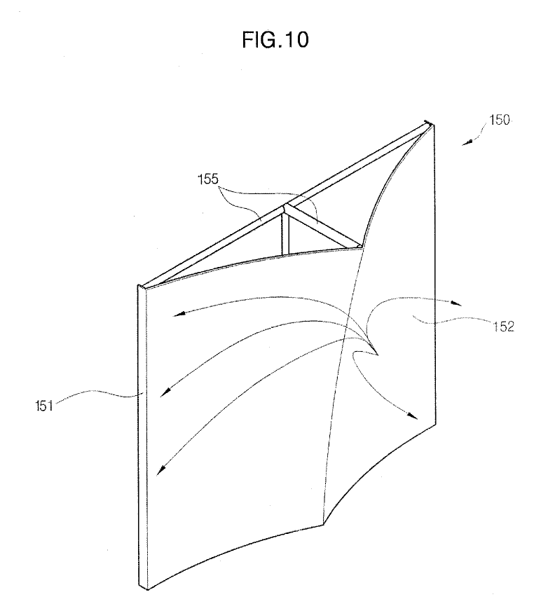

FIG. 10 is a schematic perspective view of a new type of dispersion guide member.

The dispersion guide member 150 shown in FIG. 10 is placed in the front of the inlet 11 of the oxidation pond and serves to guide the flow of mine drainage, introduced through the inlet 11, to different directions.

That is to say, while it is the norm that a usual oxidation pond is designed such that a mine drainage introduced through an inlet is directed toward an outlet, the dispersion guide member 150 guides the flow of the mine drainage in a direction which crosses with a direct direction connecting the inlet and the outlet with each other, that is, in an indirect direction.

In the embodiment of the present invention, the dispersion guide member 150 has a first wing surface 151 and a second wing surface 152 which are formed in a plate-like shape. The first wing surface 151 and the second wing surface 152 are formed as curved surfaces to guide the mine drainage introduced through the inlet 11 in the leftward direction and the rightward direction of the inlet 11 to thereby cause the mine drainage to be dispersed through the entire oxidation pond.

The dispersion guide member 150 projects more toward the inlet at the upper part thereof than the lower part thereof to naturally guide the mine drainage introduced through the inlet to the lower part of a retention pond so that the mine drainage can also be flowed through the lower part of the oxidation pond.

It is not necessary for the first wing surface 151 and the second wing surface 152 to be inevitably symmetric to each other. The first wing surface 151 and the second wing surface 152 may not be symmetric to each other in the light of the shape of the oxidation pond and a main flow direction. An angle, which the first wing surface 151 and the second wing surface 152 define with respect to the inlet direction of the mine drainage, may vary depending upon the shape of the oxidation pond and conditions.

Experiments were conducted for the performance of the dispersion guide member 150 shown in FIG. 10.

Observing experiment results, it can be seen that, in the case where the dispersion guide member 150 is installed, the dye introduced through the inlet is dispersed through the entire oxidation pond as time goes by. This is in contrast to the fact that, in the case where the dispersion guide member 150 is not installed, the dye forms a linear flow from the inlet toward the outlet.

When 10 minutes has passed after the dye is introduced, it was observed that the dye, which was mainly distributed on the left side and the right side of the oxidation pond, is gradually diffused to the center portion of the oxidation pond. Before or after 20 minutes has passed after the dye is introduced, it was observed that the dye is dispersed through the entire oxidation pond and is then discharged through the outlet.

In order to precisely measure the retention time of the dye, divers were installed at the inlet and the outlet of the oxidation pond. Further, brine as a tracer was introduced into the inlet of the mine drainage, and the retention time thereof was measured. Observing experiment results, since it is 514 seconds that the brine is initially introduced into the inlet and a time at which the brine reached the outlet seems 3,066 seconds in consideration of electrical conductivity at the outlet, the time elapsed from the inlet to the outlet is calculated as 2,552 seconds. Therefore, is can be seen that 42.5 minutes were required. As a result, it can be understood that the retention time of the mine drainage is considerably increased when compared to the conventional oxidation pond.

The following Table 2 compares the performance of the oxidation pond in the cases where the dispersion guide member shown in FIG. 10 is installed and is not installed. It can be seen from Table 2 that, while the ratio between a nominal retention time and a measured retention time is very small as 4.3% in the case where the dispersion guide member is not installed, the ratio remarkably increases to 42.5% in the case where the dispersion guide member is installed. Therefore, it is to be noted that the retention time is improved by 9.8 times when compared to the conventional art.

TABLE 2

| | Non-installation | Installation of | Installation/ |
|---|---|---|---|
| | of dispersion | dispersion | Non- |
| Item | guide member | guide member | installation |
| Nominal retention | 100 | 100 | 1.0 |
| time, N (min) | | | |
| Measured retention | 4.35 | 42.5 | 9.8 |
| time, M (min) | | | |
| M/N(%) | 4.3 | 42.5 | 9.9 |

As described above, in the embodiment of the present invention, a dispersion guide member capable of dispersing the flow of a mine drainage is installed at an inlet of an oxidation pond so that the mine drainage can be flowed through the entire oxidation pond. In detail, in the conventional art, the mine drainage flows in a direct direction connecting an inlet and an outlet and only through the upper part of the oxidation pond. Conversely, in the present invention, the flow of the mine drainage is formed additionally even through the side and lower parts of the oxidation pond which have otherwise served as stagnated regions in the conventional art, whereby the retention time of the mine drainage can be extended.

As the retention time of the mine drainage in the oxidation pond is extended in this way, the mine drainage can react with oxygen for a sufficient time, and iron ions in the mine drainage can be precipitated to the bottom of the oxidation pond and then be removed.

As is apparent from the above descriptions, in the present invention, due to the fact that the pH of mine drainage can be increased using a neutralizing agent, a precipitation reaction speed can be improved, and at the same time, the retention time of the mine drainage can be increased so that the precipitation reaction of iron can sufficiently occur, whereby most of iron ions in the mine drainage can be removed.

As described above, according to the present invention, a neutralizing agent is used to increase the pH of main drainage so as to increase the efficiency of precipitation of ionic ions in mine drainage, thereby facilitating the subsequent treatment of the mine drainage.

Also, according to the embodiments of the present invention, various types of dispersion guide members are used so that mine drainage can reside in the retention pond for a sufficient time so as to react with oxygen for a sufficient time, thereby increasing the efficiency of precipitation of iron ions in the mine drainage.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An oxidation pond for treating mine drainage, comprising: an inlet into which mine drainage is introduced; a retention pond in which the mine drainage introduced into the inlet resides; and an outlet through which the mine drainage is discharged from the retention pond, so that iron in the mine drainage is oxidized and precipitated during retention of the mine drainage in the retention pond, wherein a neutralizing agent that increases the pH of the mine drainage to accelerate a precipitation reaction of iron is placed in the retention pond.

2. The oxidation pond of claim 1, wherein the neutralizing agent is suspended in water of the retention pond.

3. The oxidation pond of claim 1, wherein the neutralizing agent is a natural limestone mass.

4. The oxidation pond of claim 1, wherein the neutralizing agent comprises limestone fine powders and a binder forming the limestone fine powders into one mass, wherein the binder is dissolved in the mine drainage while the limestone fine powders come in contact with the mine drainage.

5. The oxidation pond of claim 1, wherein the neutralizing agent is a limestone mass having a number of cracks formed by pressing.

6. The oxidation pond of claim 1, wherein the wall surface of the retention pond may be made of limestone.

7. The oxidation pond of claim 1, wherein the neutralizing agent is disposed closer to the inlet than the outlet.

8. The oxidation pond of claim 1, wherein the oxidation pond further comprises a dispersion guide member which is placed in the front of the inlet such that the mine drainage introduced into the retention pond through the inlet

9. The oxidation pond of claim 8, wherein the dispersion guide member allows mine drainage to be introduced in an indirect direction, crossing a direct direction connecting the inlet to the outlet, in an amount larger than in the direct direction, allows mine drainage to be introduced in the indirect direction, forming a relatively large angle with the direct direction, in an amount than in the indirect direction, forming a relatively small angle with the direct direction and allows mine drainage to be introduced into the lower portion of the retention pond in an amount larger than the upper portion.

10. The oxidation pond of claim 8, wherein the dispersion guide member has a bent plate shape and is placed in the retention pond while surrounding the inlet, so that it blocks the of mine drainage, wherein the length of the lower portion of the guide member, which blocks mine drainage that is discharged along the indirect direction formed at a relatively large angle with the direct direction connecting the inlet to the outlet, is relatively short.

11. The oxidation pond of claim 8, wherein the dispersion guide member has a bent plate shape and is placed in the retention pond while surrounding the inlet, so that it blocks the flow of the mine drainage, wherein a number of discharge holes are formed in the dispersion guide member, in which the sum of the areas of the discharge holes formed at the lower portion of the dispersion guide member is larger than the sum of the areas of the discharge holes formed at the upper portion, and the sum of the areas of the discharge holes formed along the indirect direction forming a relatively large angle with the direct direction connecting the inlet to the outlet is larger than the sum of the areas of the discharge holes formed along the indirect direction forming a relatively small angle with the direct direction.

12. The oxidation pond of claim 11, wherein a discharge pipe that guides mine drainage is formed along the discharge hole.

13. The oxidation pond of claim 12, wherein the length of the discharge pipe disposed at the lower portion of the dispersion guide member is longer than that of the discharge pipe disposed at the upper portion, and the length of the discharge pipe formed along the indirect direction forming a relatively large angle with the direct direction is longer than that of the discharge pipe formed along the indirect direction forming a relatively small angle with the direct direction.

14. The oxidation pond of claim 1, wherein the dispersion guide member is formed in a plate shape along the indirect direction crossing the direct direction connecting the inlet to the outlet and serves to guide the flow of the mine drainage introduced into the inlet.

15. The oxidation pond of claim 14, wherein the dispersion guide member comprises a first wing surface having a curved shape, and a second wing surface which is coupled with the first wing surface and is formed symmetrically with the first wing surface, so that the mine drainage can be dispersed along the first wing surface and the second wing surface in opposite directions.

16. The oxidation pond of claim 14, wherein the upper portion of the dispersion guide member is more protruded toward the inlet than the lower portion so that the mine drainage is guided toward the lower portion of the retention pond.
